(19) United States
(12) Patent Application Publication
(10) Pub. No.: US 2026/0364877 A1
(43) Pub. Date: Nov. 19, 2026

(54) RECOATER SYSTEM AND METHOD FOR HIGH VISCOSITY RESINS

(71) Applicant: 3D Systems, Inc., Rock Hill, SC (US)

(72) Inventors: James Francis Smith, III, Tega Cay, SC (US); Ning Zheng, Charlotte, NC (US); Andrew S. Rogers, Fort Mill, SC (US)

(21) Appl. No.: 19/671,350

(22) Filed: May 8, 2026

Related U.S. Application Data
(60) Provisional application No. 63/806,147, filed on May 15, 2025.

(51) Int. Cl. B29C 64/214; B29C 64/124; B33Y 10/00; B33Y 40/00

(52) U.S. Cl. CPC B29C 64/214; B29C 64/124; B33Y 10/00; B33Y 40/00

(57) ABSTRACT

A three-dimensional printing system includes a vessel, a build plate, a wiping mechanism, an imaging subsystem, and a controller. The vessel contains a photocurable resin having a viscosity of at least 1700 centipoise. The wiping mechanism includes a wiper blade having the following characteristics: (A) it is formed from a rigid material; (B) the blade has a major, intermediate, and minor axes defined along X, Y, and Z axes respectively; (C) the blade includes a lower portion having obliquely oriented lateral sides that widen in a downward direction; (D) the lateral sides have a horizontal wall thickness in a range of 1.50 to 2.50 millimeters; (E) the blade includes a lower planar surface surrounding an opening and having an average surface roughness of less than one micron; (F) an intersection of the lateral sides and the lower planar surface define opposing blade edges.

### CROSS-REFERENCE TO RELATED APPLICATIONS

This non-provisional patent application claims priority to U.S. Provisional Application Serial Number 63/806,147, Entitled “RECOATER SYSTEM AND METHOD FOR HIGH VISCOSITY RESINS” by James Francis Smith III et al., filed on May 15, 2025, incorporated herein by reference under the benefit of U.S.C. 119(e).

### FIELD OF THE INVENTION

The present invention concerns an apparatus and method for the digital fabrication of three-dimensional (3D) articles by a layer-by-layer selective radiative curing of a photocurable build material. More particularly, the present invention concerns an apparatus and method for the rapid and effective deposition of high viscosity resin using a wiper blade.

### BACKGROUND

3D printing systems are in wide use for prototyping and manufacturing 3D articles. One type of 3D printing system utilizes a process called stereolithography. A typical stereolithography system utilizes a liquid-containing vessel, an imaging system, and a build plate within liquid photocurable resin held by the vessel. A wiper blade is translated over the build plate to form a new layer of the photocurable resin. The imaging system is operated to selectively cure and harden the new layer. In this way, the 3D article is formed in a layer-by-layer manner.

In the discussion that follows, reference will be made to “earlier coating systems.” A related reference concerning earlier systems is the granted US patent number 5,902,537 (referred to as the ‘537 patent hereafter). The ‘537 patent illustrates a stereolithography system that is typically used to form 3D articles for temporary prototyping purposes. Such 3D articles can also have a more permanent utility but were limited by the photocurable resins used at the time of the ‘537 filing. The ‘537 patent generally discloses applicator (wiper blade) illustrations and descriptions.

More recently there has been an increasing desire to form very high performance 3D articles. To do so, relatively high viscosity photocurable resins need to be employed. At the same time, there is a desire that these high performance articles have smaller and more accurate geometries. This can require thinner coatings. The applicators disclosed in the ‘537 patent encountered technical difficulties with the combination of high viscosity and thin coatings.

By “high viscosity” we are referring to viscosities in a range of about 1700 centipoise (CPS) and higher. The viscosity can be at least 2000 CPS, at least 2500 CPS, at least 3000 CPS, or at least 3500 CPS.

By thinner, we are referring to thicknesses of less than 100 microns (0.100 millimeters or mm). The thickness can be less than 80 microns, less than 60 microns, less than 50 microns, less than 40 microns, or even less than 30 microns. A need exists to provide thinner layers of high viscosity photocurable resins.

### SUMMARY

In an aspect of the present invention, a three-dimensional (3D) printing system includes a vessel, a build plate with an upper surface positioned within the vessel, a vertical movement mechanism coupled to the build plate, a wiping mechanism, an imaging subsystem, and a controller. The vessel contains a photocurable resin having a viscosity of at least 1700 centipoise (CPS). The wiping mechanism includes a wiper blade having the following characteristics: (A) the wiper blade is formed from a rigid material such as a metal; (B) the wiper blade has a major axis defined along an X-axis, an intermediate axis defined along a vertical Z-axis, and a minor axis defined along a Y-axis; (C) the wiper blade includes a lower portion having lateral sides that are oblique with respect to the Y and Z axes with the lower portion widening in a downward (-Z) direction; (D) the lateral sides surrounding an internal recess and having a horizontal wall thickness in a range of 1.50 to 2.50 millimeters (mm) measured along the Y-axis; (E) the wiper blade including a lower planar surface surrounding an opening defined by the internal recess and having an average surface roughness (Ra) of less than one micron; (F) an intersection of a lateral side and the lower planar surface defining a blade edge. The controller is configured to (1) operate the vertical movement mechanism to position the upper surface of the build plate one layer thickness below the build plane, (2) operate the wiping mechanism to sweep or translate the wiper blade over the build plate to form a new layer of the photocurable resin above the build plate, (3) operate the imaging subsystem to selectively harden the new layer of the photocurable resin, and repeat (1)-(3) to complete fabrication of a 3D article.

The combination of characteristics (A)-(F) provide a surprising result. In particular, an accurate and defect-free formation of photocurable resin layers having individual thicknesses of 100 microns and below are possible using resins that are equal to or greater than 1700 CPS. This is surprising, since prior systems begin to fail in forming layers of 1700 CPS resin below thicknesses of 100 microns such as at 75 microns. Yet with this new system, high viscosity resin can be used to form layer thicknesses less than 50 or even less than 40 microns. Moreover, layers below 40 microns can be formed using photocurable resins having viscosities above 2000 CPS, above 2500 CPS, or even above 3000 CPS. Moreover, the higher viscosity resins can be leveled with relatively high wiper translation speeds which is important for maintaining high productivity of a 3D printer. In particular, resins having a viscosity greater than 2000 CPS, above 2500 CPS, or even above 3000 CPS can be leveled with a wiper translation speed greater than 2 inches per second without defect.

In one implementation, the horizontal wall thickness is between 1.75 and 2.25 millimeters (mm). More particularly, the horizontal wall thickness can be within a range of 1.83 mm to 2.12 mm.

In another implementation, the average surface roughness (Ra) of the lower planar surface is less than 0.75 micron. The average surface roughness (Ra) of the lower planar surface is preferably less than 0.50 micron.

In yet another implementation, the intersection of the lateral sides and the lower planar surface define a line. The blade edge has a deviation from the line of less than 0.060 millimeter.

In a further implementation, the lower planar surface has a surface flatness of 0.010 millimeter. The lower planar surface preferably defines a rake angle magnitude relative to a horizontal plane of less than plus or minus 0.005 degrees.

### BRIEF DESCRIPTION OF THE FIGURES

FIG. 1 is a schematic illustration of an embodiment of a three-dimensional (3D) printing system for manufacturing or fabricating a 3D article.

FIG. 2 is an isometric drawing that illustrates certain components of an embodiment of a three-dimensional (3D) printing system.

FIG. 3 is an isometric drawing of an embodiment of a coating subsystem in isolation.

FIG. 4 is a side view of a coater blade in isolation.

FIG. 4A is a cross section 4A-4A taken from FIG. 4.

FIG. 5 is detail taken from FIG. 4A.

FIG. 6 is a graphical representation comparing earlier coating systems with the coating system of the present invention. FIG. 6 illustrates a surprising result of the current coating system enabling a formation of thin new layers of high viscosity photocurable resin.

FIG. 7 is a graphical representation comparing earlier coating systems with the coating system of the present invention. FIG. 7 illustrates a surprising result of the current coating system enabling rapid formation of layers with high viscosity resins.

FIG. 8 is a flowchart depicting manufacture steps of a three-dimensional (3D) article.

### DETAILED DESCRIPTION OF THE PREFERRED EMBODIMENTS

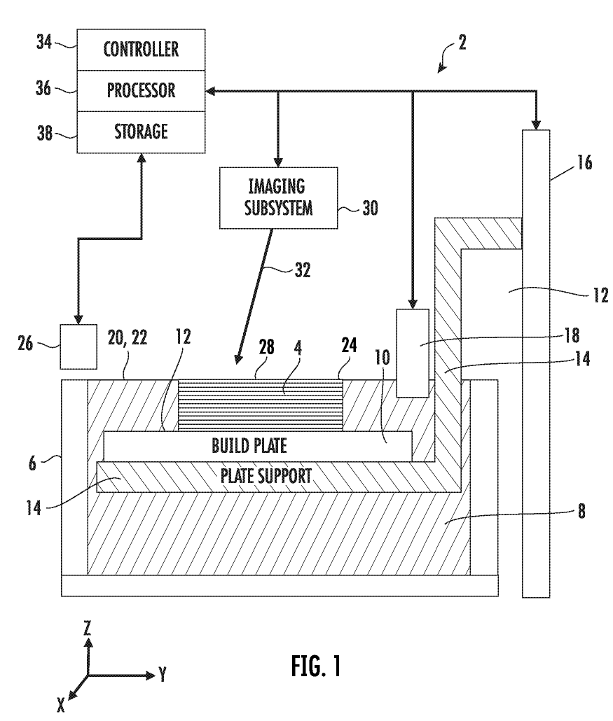

FIG. 1 is a schematic illustration of an embodiment of a three-dimensional (3D) printing system 2 for manufacturing or fabricating a 3D article 4. In describing system 2, mutually orthogonal axes X, Y, and Z will be utilized and otherwise referred to as an X-axis, a Y-axis, and a Z-axis. Axes X and Y are lateral axes that are generally horizontal. The Z-axis is a vertical axis that is generally aligned with a gravitational reference. The term “generally” implies that a direction or magnitude is not necessarily exact but is by design. Thus the term “generally horizontal” means horizontal (perpendicular to a gravitational vector) to within design and manufacturing tolerances. The term “generally aligned” means aligned to within design and manufacturing tolerances.

3D printing system 2 includes a liquid resin-containing vessel 6 configured to contain a photocurable resin 8. In the illustrated embodiment, photocurable resin 8 includes, inter alia, a monomer, a catalyst, and a filler. The catalyst allows the resin 8 to be hardened and cured with an application of radiation such as blue radiation, violet radiation, or ultraviolet radiation that would typically have a wavelength distribution within a range of 500 to 100 nm (nanometers). Photocurable resins for stereolithography systems are known in the art.

In the illustrated embodiment, the photocurable resin 8 has a high viscosity. By “high viscosity” it is implied that the viscosity has a magnitude of 1700 centipoise (CPS) or more, 2000 CPS or more, 2500 CPS or more, 3000 CPS or more, or 3500 CPS or more. Compared to lower viscosities, the high viscosity photocurable resins result in improved mechanical strength properties of the finished 3D article 4.

System 2 includes a build plate 10 with an upper surface 12 upon which the 3D article 4 is formed. A build plate support structure 14 supports build plate 10. A vertical movement mechanism 16 is operable to vertically position the build plate support structure 14 and in doing so vertically position the build plate 10. In one embodiment, the vertical movement mechanism 16 includes a fixed motor coupled to a lead screw. The build plate support structure 14 includes a threaded bearing that receives the lead screw. As the motor turns the lead screw, the effect is to controllably translate the build plate support structure 14 up or down. In addition, the vertical movement mechanism 16 and the build plate support structure 14 include mutually engaging linear bearings that assure linear motion of the build plate support structure along the vertical axis Z. Various vertical and lateral movement mechanisms are known in the field of stereolithography. All typically include linear bearings for guiding motion but the movement can be based upon a lead screw, a rack and pinion system, a belt and pulley system, or various well-known means of imparting precision motion.

System 2 includes a resin level subsystem 18 configured to maintain a resin upper surface 20 at a predetermined vertical position. In the illustrated embodiment, the resin upper surface 20 is generally coincident with a build plane 22. The resin level subsystem 18 can include a resin level sensor and a weight coupled to a pully system. The weight is partially immersed in the resin 8 such that raising and lowering the weight alters a vertical position of the resin upper surface 20 via volumetric displacement. The resin level sensor outputs a signal indicative of a vertical position of the resin upper surface 20. The signal is analyzed and the pully system is operated to raise and lower the weight to maintain the resin upper surface 20 to be generally coincident with the build plane 22.

An “upper surface” 24 can be defined which is either the upper surface 12 of the build plate 10 or an upper surface 24 of the 3D article 4 when it is partially formed. Before forming an additional material layer onto the 3D article 4, the upper surface 24 is positioned at a vertical position that is generally one material layer thickness below the build plane 22.

In the illustrated embodiment, the layer thickness between the upper surface and the build plane can have a layer thickness magnitude of 100 microns or less. One micron equals one thousandth of a millimeter (mm). Other layer thicknesses can be 75 microns or less, 50 microns or less, 40 microns or less, or 30 microns or less.

System 2 includes a coating subsystem 26. After upper surface 24 is positioned one layer thickness below build plane 22, the coating subsystem 26 is configured to pass over the upper surface and to define a new layer 28 of the resin 8 over the upper surface 24. Details of the coating subsystem 26 will be discussed infra. The new layer 28 of resin 8 has the resin upper surface 20 that is generally coincident with build plane 22.

System 2 includes an imaging subsystem 30. In a first illustrative embodiment, the imaging subsystem can include one or more projection light engines. The projection light engine includes a radiation source, a spatial light modulator, and projection optics. The radiation source can be based upon light emitting diodes (LEDs) or a mercury arc lamp to name two examples. The output from the light source has a radiative spectral distribution in the blue to ultraviolet range or a wavelength between 500 nanometers (nm) to 100 nm. The spatial light modulator can be a micromirror array. Between the various components are light directing mirrors and/or lenses. Such projection light engines are known in the art for stereolithography.

In a second embodiment, the imaging subsystem 30 is configured to scan an energy beam 32 over the build plane 22 to selectively cure and harden the new layer 28 of resin 8 and to form a new material layer of the 3D article 4. In an illustrative embodiment, imaging subsystem 30 includes a laser that generates a radiation beam 32 that is reflected by a scanner. The scanner scans the radiation beam 32 over the build plane 22. In an illustrative embodiment, the scanner includes two galvanometer mirrors including an X-mirror and a Y-mirror configured to scan the radiation beam along the X-axis and the Y-axis respectively over the build plane 22. Imaging subsystems are known in the field of stereolithography. Another imaging subsystem can be based upon a ”light bar array” of light emitting devices that scans over the build plane 22. All such radiation subsystems are well known in the art. Typically, stereolithography light engines utilize light sources having a spectral distribution in the blue to ultraviolet range.

A controller 34 is coupled to the vertical movement mechanism 16, the resin level subsystem 18, the coating subsystem 26, the imaging subsystem 30, and other portions of system 2. The controller 34 includes a processor 36 (such as a CPU or central processing unit) coupled to a non-transient or non-volatile information storage device 38 (such as flash memory or a magnetic disk drive). Storage device 38 stores software instructions. Controller 34 is configured to operate the portions of system 2 as the processor 36 executes the software instructions stored on the information storage device 38. Controller 34 can includes a single unit that is physically within illustrated system 2 or it can include a plurality of control units that can be co-located with and/or remotely located relative to the illustrated system 2.

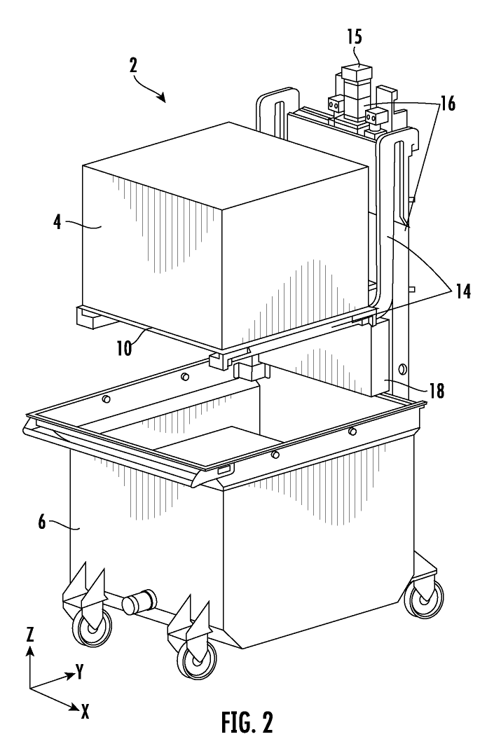

FIG. 2 is an isometric drawing that illustrates certain components of an embodiment of system 2. In the illustrated embodiment from a user point of view the axes X, Y, and Z can be described. The lateral X-axis extends from left to right. The lateral Y-axis extends from front to back or from front to rear. The vertical Z-axis extends upward. The illustrated components include the resin vessel 6, build plate 10, build plate support structure 14, vertical movement mechanism 16, and resin level subsystem 18 (the weight that is raised and lowered). The vertical movement mechanism 16 includes a motor 15 coupled to a vertical lead screw for providing vertical positioning of the build plate support structure 14 and the build plate 10. Between the build plate support structure 14 and the vertical movement mechanism 16 are a pair of linear bearings (hidden in this figure) to control linearity of motion along the Z-axis. Not illustrated is the coating subsystem 26 and imaging subsystem 30.

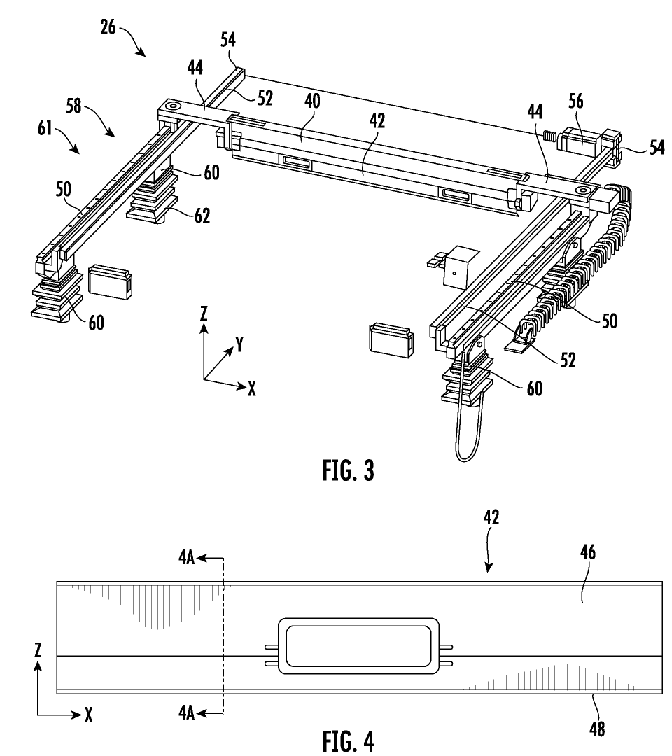

FIG. 3 is an isometric drawing of an embodiment of a coating subsystem 26 in isolation. Coating subsystem 26 includes a wiper module 40 or coater module 40 which includes a coater blade 42 that is supported between at least one end portion 44 at opposed ends of the coater blade 42 with respect to the lateral X-axis.

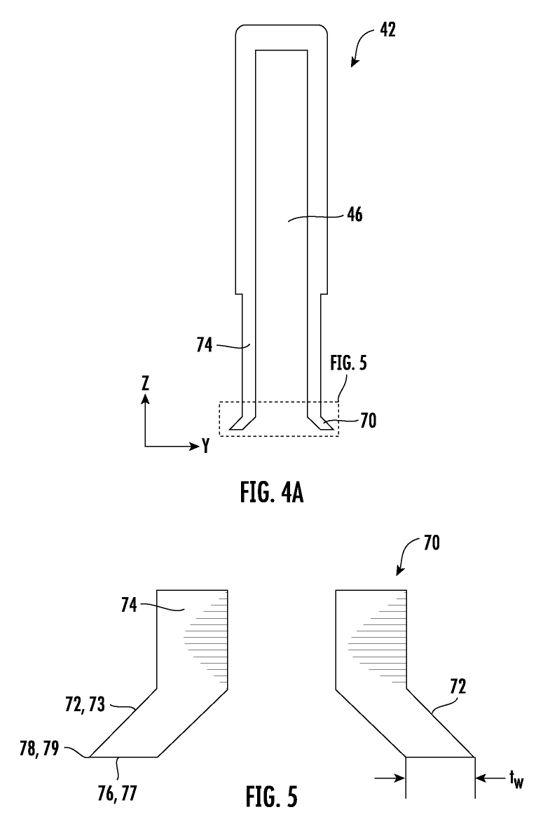

FIG. 4 is a side view of the coater blade 42 in isolation. The coater blade 42 has an internal recess 46 (not directly shown) that is at least partially filled with the photocurable resin 8 to facilitate coating irregular upper surfaces 24 of the 3D article 4. Coater blade 42 also has lower edge 48.

Coater blade 42 is formed from a rigid material such as a metal or high performance plastic. In one illustrative embodiment, the rigid material is nickel plated aluminum. In another illustrative embodiment, the rigid material is stainless steel with a passivation layer. Other materials are possible.

Referring back to FIG. 3, coating subsystem 26 of the illustrated embodiment includes a pair of linear bearings 50 at opposed ends of the coater module 40 with respect to the X-axis. The end portions 44 are in sliding engagement with and supported by the linear bearings 50. The end portions 44 slide upon the linear bearings 50 along the Y-axis.

Two belts 52 are individually supported by pulleys 54 at opposed ends of the coater module 40. The belts 52 are attached to the end portions 44 at the opposed ends of the coater module 40. A motor 56 is coupled to two of the pulleys 54. Rotation of the pulleys 54 by motor 56 causes movement of the belt and translation of the coater module 40 along the Y-axis in sliding engagement and support by the linear bearings 50. The combination of the motor 56, pulleys 54, belts 52, and other possible components can be referred to as a “lateral movement mechanism” 58 for transporting coater module 40 along the Y-axis.

A set of four vertical actuators 60 support and vertically position the linear bearings 50. The vertical actuators 60 are individually coupled between a vertical support 62 and one of the linear bearings 50. The linear bearings 50 individually are supported by a front vertical actuator 60 and a rear vertical actuator 60 which enables a height and angular tilt of each linear bearing 50 to be adjusted. In one embodiment, the vertical actuators 60 individually include a motorized lead screw that turns and thereby raises or lowers a nut that is attached to one end portion of one of the linear bearings 50. The set of four vertical actuators 60 and other associated components can be referred to as a “vertical actuator system” 61.

FIG. 4A is a cross section 4A-4A taken from FIG. 4. As illustrated, the wiper blade 42 has an internal recess 46 for containing photocurable resin 8. A lower portion 70 of the wiper blade 42 is referred to as “FIG. 5” and is illustrated in detail in FIG. 5.

The lower portion 70 has opposed lateral sides 72 that are obliquely oriented with respect to lateral axis Y and vertical axis Z. In the illustrated embodiment, the oblique orientation defines a 45 degree angle relative to the Y and Z axes. The oblique orientation of lateral sides 72 results in the blade 42 widening in a downward (-Z) direction from a straight middle lateral section 74 to a lower planar surface 76. An intersection between a lateral side 72 and the lower planar surface 76 defines a blade edge 78. Thus, there are two opposed blade edges 78 at opposed edges of the blade 42 to enable the blade 42 to bidirectionally level photocurable resin 8.

The blade edge 78 ideally defines a line (or ideal line) that is parallel to the X-axis. In practice, the blade edge 78 has deviations (intrusions or protrusions) at which the blade edge 78 deviates from the ideal line. The deviations are less than 0.060 millimeter in radial extent (r) from the ideal line. If we define r as equal to a deviation from the ideal line, then r is maintained below 0.060 millimeter (less than 60 microns).

One way to define the ideal line 79 (FIG. 5) is to define an intersection between two planes 73 and 77. Plane 73 is a mathematical fit (perhaps using a known least squares method) to the surface 72. Plane 77 is a mathematical fit to the surface 76. Ideal line 79 extends along the intersection of planes 73 and 77. The distance r is a radial distance between surfaces of the actual edge 78 and the ideal line 79. Methods for forming surfaces 72 and 76 assure that the distance r is always below 60 microns along blade edge 78.

The lower portion 70 has a horizontally defined wall thickness t_{w}. The horizontal wall thickness t_{w} is between 1.5 millimeter (mm) and 2.5 millimeter (mm) as measured along the Y-axis which is parallel to the sweep or translation axis for the wiper 42. Preferably, the horizontal wall thickness t_{w} is between 1.75 and 2.25 mm. In an illustrative embodiment, the horizontal wall thickness t_{w} is between 1.83 and 2.12 mm. In a particular illustrative embodiment, the horizontal wall thickness t_{w} is 1.83 mm.

The lower planar surface 76 has a surface flatness within 0.010 millimeter (10 microns). A plane can be defined by the lower planar surface 76. This can be defined as a “least squares plane” that fits various points of lower planar surface 76 to a plane using a known numerical analysis technique. A deviation delta-Z is a distance that a point, location, or region on the lower planar surface deviates vertically from the defined plane. Delta-Z is maintained below 10 microns.

The lower planar surface 76 defines a rake angle relative to a horizontal plane. The rake angle is preferably maintained to less than plus or minus 0.005 degrees or 0.003 degrees. Stated another way, the plane 77 defines a rake angle with respect to a horizontal plane of less than plus or minus 0.005 degrees or 0.003 degrees.

The lower planar surface 76 has an average surface roughness (Ra) of less than 1 micron. More preferably, the average surface roughness (Ra) is less than 0.75 micron. Yet more preferably, the average surface roughness (Ra) is less than 0.50 micron. Even more preferably, the average surface roughness (Ra) is in a range of 0.15 and 0.50 micron.

Taken in combination in various embodiments of the present invention, the blade edge 78 structure, the horizontal wall thickness t_{w} of the lower portion 70, planarity, rake angle, and/or the average surface roughness (Ra) of the lower planar surface 76 enable the wiper blade 42 to define very thin individual layers (less than 100 microns) of high viscosity (at least 1700 CPS) photocurable resin under the build plane 22 above a previously formed and selectively hardened layer. This surprising result can be accomplished at practical (meaning not too slow) translation speeds of the wiper blade 42. Generally speaking, it is preferred that the translation speed be at least two inches per second for most operational conditions.

One prior art solution that has been employed is to slow a translation speed of a wiper blade. This solution can work as viscosity is increased at or above 1700 CPS and thicknesses are decreased below 100 microns but generally cannot operate defect-free for the full range of desired viscosities and thicknesses. For example, the new layer will not be consistently flat across the surface, will have mounding on some edges, will have a bow to the profile, will have edges that are not sharp, will have ripple patterns on the surface, and the like. Moreover, slowing down the translation speed can drastically increase a cycle time for fabricating an article. Generally speaking, translation speeds at or above about 2 inches per second are desirable to achieve acceptable cycle time and productivity of stereolithography systems.

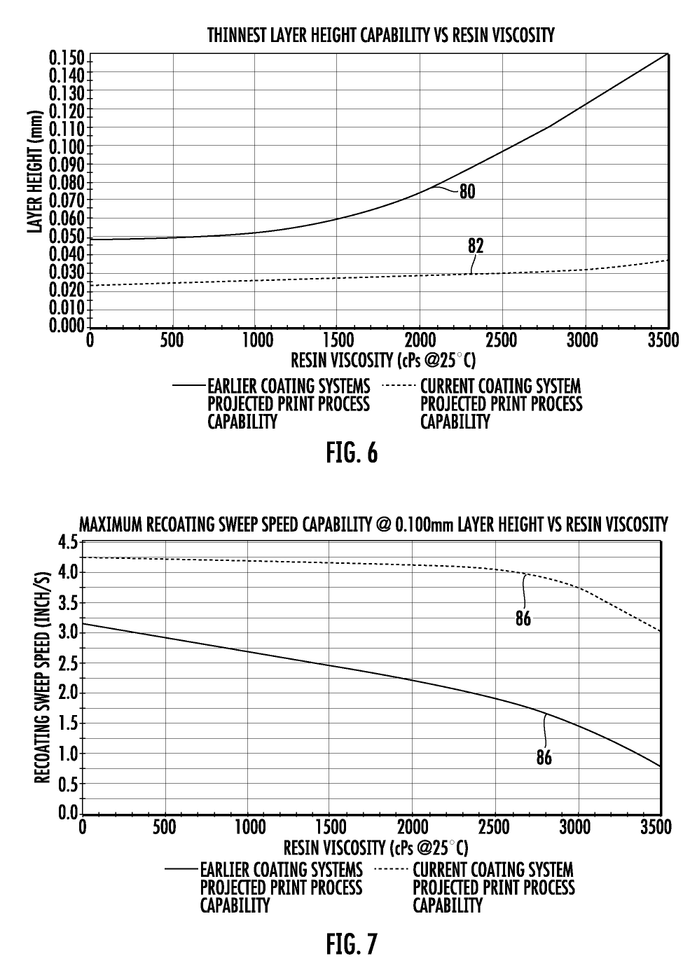

FIG. 6 illustrates a comparison between wiper blade 42 and an earlier wiper blade design such as the ‘537 patent applicator. The graphs plot thinnest layer heights versus photocurable resin viscosity. The upper curve 80 illustrates limitations of an earlier design for a given translation speed. With photocurable resin having a viscosity of 1700 centipoise (CPS), the earlier design cannot form a layer of less than 0.060 mm (60 microns). As the viscosity increases, the minimum layer thickness rises rapidly – above 70 microns at 2000 CPS, above 90 microns at 2500 CPS, and above 120 microns at 3000 CPS, and above 140 microns at 3500 CPS.

In contrast, the lower curve 82 illustrates a surprising capability of the newer wiper blade 42. The wiper blade 42 can form coating thicknesses of 30 microns even with very high viscosities as indicated. At 1700 to 2500 CPS, the new wiper blade can form layer thicknesses at or below 30 microns. The minimum thickness is less than 40 microns with a viscosity of 3000 or 3500 CPS. Thus, the new wiper blade enables thin layers of high viscosity resin relative to the earlier design.

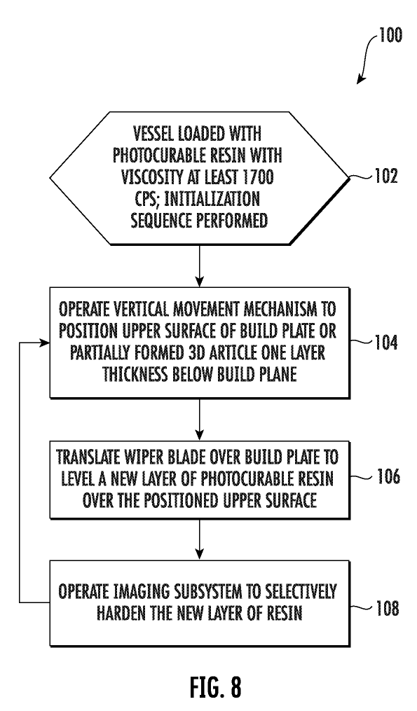

FIG. 7 illustrates a comparison of translation speeds for wiper blade 42 and earlier designs for forming 100 micron layers. The lower curve 84 shows the result for the earlier design. Lower translation speeds have a very deleterious effect on a 3D printer 2 productivity. Moreover, there is no practical operating point for thinner layers which are important for high resolution 3D printing. At 1700 or 2000 CPS, the maximum wiper speed is below 2.5 inches per second. At 2500 CPS, the maximum wiper speed must be below 2.0 inches per second. At 3000 CPS, the maximum wiper speed is below 1.5 inches per second. At 3500 CPS, the maximum wiper speed is below one inches per second.

In contrast, the upper curve 86 shows a surprising result for the new wiper blade 42. The 3D printer 2 can maintain reasonable productivity even for very high viscosities of over 3000 CPS. For viscosities of 1700, 2000, and even 2500 CPS the wiper speed can be four inches per second. For 3000 CPS, the wiper speed can be 3.5 inches per second. For 3500 CPS, the wiper speed can be 3.0 inches per second. Thus, the newer wiper design provides a large productivity improvement that becomes more pronounced with higher viscosities.

FIG. 8 is a flowchart depicting a manufacturing method 100 for forming the 3D article 4. According to step 102, a 3D printing system 2 as described supra is provided with photocurable resin having a viscosity of at least 1700 centipoise (CPS). Also as part of step 102, the system 2 is initialized which may include calibration. Steps 104 to 108 are performed by controller 34 as processor 36 executes software instructions stored upon non-volatile or non-transient storage media 38.

According to 104, the vertical movement mechanism 16 is operated to position the upper surface 24 (of build plate 10 or 3D article 4) one layer thickness below the build plane 22. According to 106, the coater blade is swept or translated along the Y-axis and over the build plane 22 to level a new layer of the photocurable resin 8 over upper surface 24. According to 108, the imaging subsystem (micromirror projector(s), scanned laser(s), light bar, or other) 30 to selectively cure and harden the new layer of photocurable resin 8. Steps 102 to 108 are repeated to complete fabrication for the manufacture of 3D article 4.

In prior art approaches, as the viscosity increases and thickness decreases the applicators can form various defects. The resultant layers can have mounding over underlying edges, ripple patterns, and other defects. In general, the resultant layers of prior art systems may not achieve desired planarity, flatness, and required dimensional control.

Another approach used by prior art systems has been to elevate a temperature of resins to lower the viscosity during wiper translation. However, heating the resin can lower the shelf life of the resin. Photocurable resins are very expensive materials, so shortening the usable life of the resin is a big drawback. Additionally, the heated resin generates organic fumes which need to be captured and condensed to protect operators of the stereolithography systems. Yet another challenge is to maintain a uniform temperature to enable uniform layer formation. All of these issues – resin deterioration, safety to operators, and consistent quality – are issues for elevated temperatures, which the present invention avoids by enabling stereolithography systems to be operated at or near room temperature (about 25 degrees Celsius). The present invention increases the parametric range to include much or all of a viscosity range of 1700 to 3500 CPS and thicknesses in a range of 100 to 30 microns, while enabling translation speeds at or above about 2 inches per second.

The specific embodiments and applications thereof described above are for illustrative purposes only and do not preclude modifications and variations encompassed by the scope of the following claims.

What is claimed is:

1. A three-dimensional (3D) printing system configured to manufacture a 3D article comprising:
a vessel containing photocurable resin having a viscosity of at least 1700 centipoise (CPS);
a build plate with an upper surface;
a vertical movement mechanism coupled to the build plate;
a wiping mechanism including a wiper blade having the following characteristics:
the wiper blade is formed from a rigid material;
the wiper blade having a major axis defined along an X-axis, an intermediate axis defined along a vertical Z-axis, and a minor axis defined along a Y-axis;
the wiper blade including a lower portion having lateral sides that are oblique with respect to the Y and Z axes, the lower portion widening in a downward direction with respect to the Z-axis;
the lateral sides surrounding an internal recess and individually having a horizontal wall thickness in a range of 1.50 to 2.50 millimeters (mm) as measured along the Y-axis;
the wiper blade including a lower planar surface surrounding an opening defined by the internal recess, the lower planar surface having an average surface roughness (Ra) of less than 1 micron;
an intersection of a lateral side and the lower planar surface defining a blade edge;
an imaging subsystem; and
a controller configured to:
operate the vertical movement mechanism to position the upper surface of the build plate one layer thickness below the build plane;
operate the wiping mechanism to translate the wiper blade over the build plate to form a new layer of the photocurable resin above the build plate; and
operate the imaging subsystem to selectively harden the new layer of the photocurable resin.

2. The three-dimensional (3D) printing system of claim 1 wherein the one layer thickness is less than or equal to 100 microns.

3. The three-dimensional (3D) printing system of claim 1 wherein the one layer thickness is less than 75 microns.

4. The three-dimensional (3D) printing system of claim 1 wherein the one layer thickness is less than 50 microns.

5. The three-dimensional (3D) printing system of claim 1 wherein the one layer thickness is less than 40 microns.

6. The three-dimensional (3D) printing system of claim 1 wherein the one layer thickness is less than 100 microns and the viscosity is at least 2000 CPS.

7. The three-dimensional (3D) printing system of claim 1 wherein the one layer thickness is less than 100 microns and the viscosity is at least 2500 CPS.

8. The three-dimensional (3D) printing system of claim 1 wherein the one layer thickness is less than or equal to 100 microns and the wiper blade is translated at a speed of at least three inches per second to form the new layer of the photocurable resin.

9. The three-dimensional (3D) printing system of claim 1 wherein the one layer thickness is less than or equal to 100 microns and the wiper blade is translated at a speed of at least 2.5 inches per second to form the new layer of the photocurable resin when the photocurable resin viscosity is more than 2000 CPS.

10. The three-dimensional (3D) printing system of claim 1 wherein the one layer thickness is less than or equal to 100 microns and the wiper blade is translated at a speed of at least two inches per second to form the new layer of the photocurable resin when the photocurable resin viscosity is more than 3000 CPS.

11. The three-dimensional (3D) printing system of claim 1 wherein the horizontal wall thickness is between 1.75 mm and 2.25 mm.

12. The three-dimensional (3D) printing system of claim 1 wherein the average surface roughness (Ra) is less than 0.75 micron.

13. The three-dimensional (3D) printing system of claim 1 wherein the average surface roughness (Ra) is less than 0.50 micron.

14. The three-dimensional (3D) printing system of claim 1 wherein the intersection of the lateral sides and the lower planar surface define a line, the blade edge has a deviation from the line of less than 0.060 millimeter.

15. The three-dimensional (3D) printing system of claim 1 wherein the lower planar surface has a surface flatness within 0.010 millimeter.

16. The three-dimensional (3D) printing system of claim 1 wherein the lower planar surface defines a rake angle magnitude relative to a horizontal plane of less than plus or minus 0.005 degrees.

17. A method of manufacturing a three-dimensional (3D) article comprising:
providing a printing system including:
a vessel containing photocurable resin having a viscosity of at least 1700 centipoise (CPS);
a build plate with an upper surface;
a vertical movement mechanism coupled to the build plate;
a wiping mechanism including a wiper blade having the following characteristics:
the wiper blade is formed from a rigid material;
the wiper blade having a major axis defined along an X-axis, an intermediate axis defined along a vertical Z-axis, and a minor axis defined along a Y-axis;
the wiper blade including a lower portion having lateral sides that are oblique with respect to the Y and Z axes, the lower portion widening in a downward direction with respect to the Z-axis;
the wiper blade including a lower planar surface surrounding an opening and having a horizontal wall thickness in a range of 1.50 to 2.50 millimeters (mm) measured along the Y-axis, the lower planar surface having an average surface roughness (Ra) of less than 1 micron;
an intersection of the lateral sides and the lower planar surface defining a blade edge;
an imaging subsystem; and
operating the vertical movement mechanism to position the upper surface of the build plate one layer thickness below the build plane, the one layer thickness less than or equal to 100 microns;
operating the wiping mechanism to translate the wiper blade over the build plate to form a new layer of the photocurable resin above the build plate; and
operating the imaging subsystem to selectively harden the new layer of the photocurable resin.

18. The method of claim 17 wherein the one layer thickness is less than 75 microns.

19. The method of claim 17 wherein the one layer thickness is less than 50 microns.

20. The method of claim 17 wherein the one layer thickness is less than 40 microns.

21. The method of claim 17 wherein the viscosity is at least 2000 CPS.
